(19) United States
(12) Patent Application Publication
(10) Pub. No.: US 2019/0335060 A1
(43) Pub. Date: Oct. 31, 2019

(54) IMAGE READING APPARATUS

(71) Applicant: TOSHIBA TEC KABUSHIKI KAISHA, Tokyo (JP)

(72) Inventor: Naoyuki MISAKA, Mishima Shizuoka (JP)

(73) Assignee: TOSHIBA TEC KABUSHIKI KAISHA, Tokyo (JP)

(21) Appl. No.: 15/962,613

(22) Filed: Apr. 25, 2018

(51) Int. Cl. H04N 1/401; H04N 1/193; H04N 1/00; H04N 1/409

(52) U.S. Cl. CPC H04N 1/401; H04N 1/1938; H04N 1/0289; H04N 1/4097; H04N 1/00013

(57) ABSTRACT

An image reading apparatus includes a carriage, a reference plate, a transportation mechanism, and a processor. The carriage acquires an image in a main scanning direction. The transportation mechanism transports the carriage in a sub-scanning direction. The processor causes the carriage to move in a first direction using the transportation mechanism and thereby detects foreign matter that is present on the reference plate, using the carriage. When the carriage is caused to move in the first direction and thus shading data is acquired from the reference plate, the processor reads the shading data from a data acquisition area other than an area where the foreign matter is present. If the carriage is caused to move in a second direction that is opposite to the first direction and thereby shading data is acquired from the reference plate, the processor reads the shading data from the data acquisition area.

### FIELD

Embodiments described herein relate generally to an image reading apparatus.

### BACKGROUND

An image reading apparatus such as a scanner is known to read a reference plate using a carriage and thus perform shading correction. This type of image reading apparatus specifies an area of the reference plate where an unwanted material is not present, as a data reading position of shading data.

The image reading apparatus causes the scanner to move in a prescribed direction and read the reference plate, and thus specifies the data reading position that is necessary when the carriage is caused to move in the prescribed direction. Furthermore, the image reading apparatus causes the carriage to move in the opposite direction and reads the reference plate, and thus specifies the data reading position that is necessary when the carriage is caused to move in the opposite direction.

### DESCRIPTION OF THE DRAWINGS

FIG. 1 is a cross-sectional diagram illustrating an example of an image reading apparatus according to some embodiments.

FIG. 2 is a diagram illustrating an operational example of the image reading apparatus according to some embodiments.

FIG. 3 is a diagram illustrating a block that is set by the image reading apparatus according to some embodiments.

FIG. 4 is a diagram illustrating an operational example of the image reading apparatus according to some embodiments.

FIG. 5 is a diagram illustrating a block that is set by the image reading apparatus according to some embodiments.

FIG. 6 is a diagram illustrating an operational example of the image reading apparatus according to some embodiments.

FIG. 7 is a diagram illustrating a block that is set by the image reading apparatus according to some embodiments.

### DETAILED DESCRIPTION

According to some embodiments, an image reading apparatus includes a carriage, a reference plate, a transportation mechanism, and a processor. The carriage is configured to acquire an image in a main scanning direction. The transportation mechanism is configured to transport the carriage in a sub-scanning direction. The processor is configured to cause the carriage to move in a first direction using the transportation mechanism and thus detects foreign matter that is present on the reference plate, using the carriage. When the carriage is caused to move in the first direction and thus shading data is acquired from the reference plate, the processor reads the shading data from a data acquisition area other than an area where the foreign matter is present. When the carriage is caused to move in a second direction that is opposite to the first direction and thereby shading data is acquired from the reference plate, the processor reads the shading data from the data acquisition area.

Embodiments will be described in detail below with reference to the drawings.

An image reading apparatus according to some embodiments reads an image from an original document that is placed on an original document stand. The image reading apparatus includes the carriage for reading an image in the main scanning direction. The image reading apparatus causes the carriage to move in the sub-scanning direction that intersects the main scanning direction, and reads an image of an entire original document.

Furthermore, the image reading apparatus reads an image from an original document that is set in an original document supply unit. The image reading apparatus causes the carriage to move to a prescribed position. The image reading apparatus causes the original document to pass on the carriage using a transportation roller of the original document supply unit, and thus reads an image of the original document.

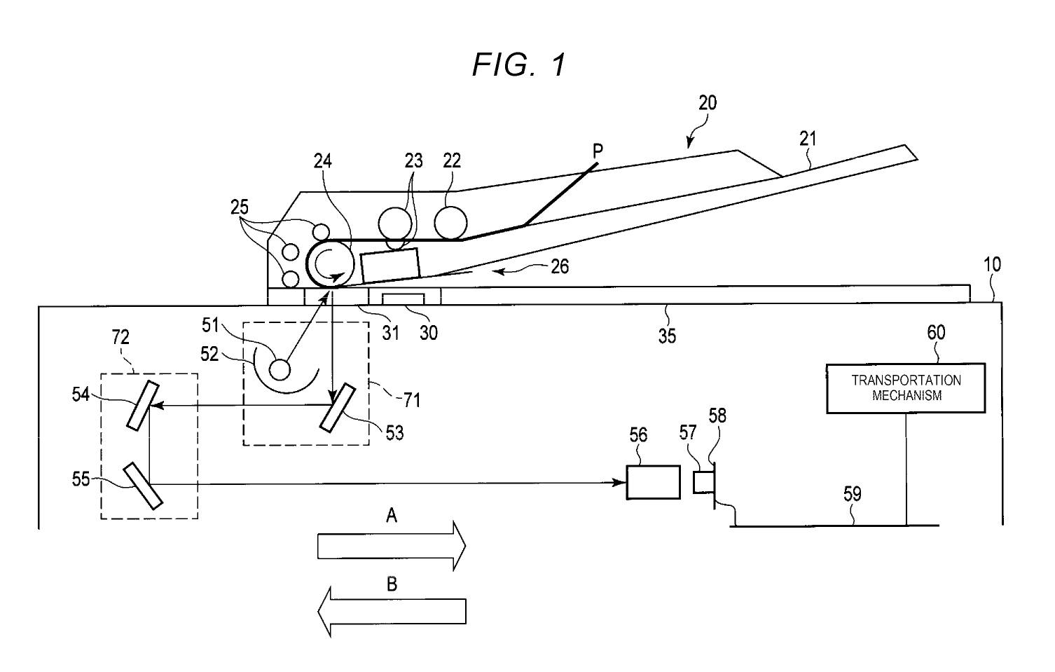

FIG. 1 is a cross-sectional diagram of the image reading apparatus 1. The leftward direction in FIG. 1 is defined as an A direction (the first direction), and a direction opposite to the A direction is defined as a B direction (the second direction).

As illustrated in FIG. 1, the image reading apparatus 1 includes a case 10, an original document supply unit 20, a white reference plate 30, a DF reading glass pane 31, an original document stand glass pane 35, a lens 56, a charge coupled device (CCD) sensor 57, a CCD sensor substrate 58, a control substrate 59, a transportation mechanism 60, a first carriage 71, a second carriage 72, and the like. The image reading apparatus 1 is assumed to be one that reads an image from an original document P.

The case 10 constitutes an outer covering of the image reading apparatus 1.

The original document supply unit 20 is formed on the case 10. The original document supply unit 20 sends original document P to the DF reading glass pane 31.

The original document supply unit 20 may be configured with a supply stand 21, a pickup roller 22, a resistance roller 23, a belt transportation drum 24, a transportation roller 25, and the like.

The supply stand 21 is a stand for setting the original document P. The supply stand 21 is formed in such a manner as to extend in a prescribed direction (the A direction). Furthermore, the supply stand 21 supplies the original document P that is set, to the pickup roller 22, and because of this, is obliquely formed. The supply stand 21 may be one for setting a plurality of original documents P.

The pickup roller 22 is a roller for picking up the original document P that is set in the supply stand 21. The pickup roller 22 picks up the original document P one by one. The pickup roller 22 supplies the picked-up original document P to the resistance roller 23.

The resistance roller 23 transports or stops the picked-up original document P. The resistance roller 23 supplies the original document P to a transportation belt and the transportation roller 25 at a prescribed timing.

The belt transportation drum 24 is a drum for driving a transportation belt for transporting the original document P. The belt transportation drum 24 drives the transportation belt by rotating on its own axis.

The transportation roller 25 is a roller that transports the original document P. The transportation roller 25 transports the original document P in a state of being interposed between the transportation roller 25 and the transportation belt. In an example that is illustrated in FIG. 1, the transportation roller 25 is formed adjacent to an outer circumstance of the belt transportation drum 24.

The transportation roller 25 sends the original document P to the DF reading glass pane 31. The transportation roller 25 sends the original document P to the DF reading glass pane 31, and then discharges the original document P to the original document discharge unit 26.

The white reference plate 30 is a colored member that serves as a white reference for a reading image of the CCD sensor 57. The white reference plate 30 may be a white plate that is formed to have a rectangular shape. The white reference plate 30 is formed in the main scanning direction in which the first carriage 71 reads an image. That is, the white reference plate 30 is formed in a direction that is perpendicular to the page in FIG. 1. Furthermore, the white reference plate 30 is formed to have a width in the main scanning direction, which is greater than a width of an image that is acquired by the CCD sensor 57 in the main scanning direction.

The DF reading glass pane 31 is formed from rectangular glass. The DF reading glass pane 31 is formed to extend in the main scanning direction. The DF reading glass pane 31 is formed to be adjacent to the white reference plate 30. The DF reading glass pane 31 is used when reading (document feeder (DF) reading) of the original document P that is sent by the original document supply unit 20 is performed. That is, the first carriage 71 reads the original document P through the DF reading glass pane 31.

The original document stand glass pane 35 is formed from rectangular glass. The original document stand glass pane 35 is formed to be adjacent to the white reference plate 30 that extends in an opposite direction to the DF reading glass pane 31. The original document P is placed on the original document stand glass pane 35. The original document stand glass pane 35 is formed to be greater than a maximum sized original document that is possibly read by the image reading apparatus 1. The original document stand glass pane 35 is formed in such a manner as to be built into the case 10. That is, the original document stand glass pane 35 transmits light between the original document P and the first carriage 71.

The first carriage 71 acquires an image in the main scanning direction that is perpendicular to the page in FIG. 1, from the original document P. The first carriage 71 acquires light in the main scanning direction, and reflects the acquired light to the second carriage 72. The first carriage 71 is formed to be within the case 10, and moves along an upper surface of the case 10 in the sub-scanning direction (the A direction or B direction). The first carriage 71 is formed in a position in which light that is reflected from the white reference plate is acquirable when passing. Furthermore, the first carriage 71 is formed in a position in which light that passes through the DF reading glass pane 31 and is reflected from the original document P is acquirable. Furthermore, the first carriage 71 is formed in a position in which light that is reflected from the original document P on the original document stand glass pane 35 is acquirable.

The first carriage 71 is configured with a light source 51, a reflector 52, a first mirror 53, and the like.

The light source 51 emits light that illuminates the white reference plate 30, the original document P, and the like. For example, the light source 51 may be configured with an LED, a fluorescent lamp, or the like.

The reflector 52 focuses light that is emitted by the light source 51 on a prescribed area. The reflector 52 cause light to focus on an area where the first carriage 71 acquires an image. For example, the reflector 52 is formed to have a prescribed radius R, and is formed to cover the light source 51. The inside of the reflector 52 reflects light.

The first mirror 53 reflects light from a prescribed area at a prescribed angle to the second carriage 72. The first mirror 53 is formed to be at a prescribed angle within the first carriage 71. The first mirror 53 reflects light in the B direction.

The second carriage 72 reflects light from the first carriage 71 to the lens 56.

The second carriage 72 includes a second mirror 54, a third mirror 55, and the like.

The second mirror 54 reflects light from the first carriage 71 to the third mirror 55. The second mirror 54 is installed to be at almost the same height as the first mirror 53. The second mirror 54 reflects light from the first mirror 53 downward.

The third mirror 55 reflects light from the second mirror 54 to the lens 56. The third mirror 55 is formed almost directly under the second mirror 54. The third mirror 55 reflects light from the second mirror 54 almost in parallel to the A direction.

The lens 56 causes light from the second carriage 72 to form an image on the CCD sensor 57. The lens 56 is installed in a position that is almost in parallel to the third mirror 55. The lens 56 causes light from the third mirror 55 to form an image on the CCD sensor 57.

The CCD sensor 57 (an optical sensor) converts light from the lens 56 into a signal. For example, the CCD sensor 57 is configured with a plurality of photoelectric conversion elements that correspond to reading elements, respectively, in the main scanning direction. Each photoelectric conversion element of the CCD sensor 57 generates a signal in accordance with light intensity, and transmits the generated signal to the CCD sensor substrate 58.

The CCD sensor substrate 58 controls the CCD sensor 57 according to a signal from the control substrate 59. For example, the CCD sensor substrate 58 supplies power to the CCD sensor 57. Furthermore, the CCD sensor substrate 58 transmits a signal from the CCD sensor 57 to the control substrate 59.

The transportation mechanism 60 causes the first carriage 71 to move in the A direction or the B direction based on a signal from the control substrate 59. The transportation mechanism 60 is configured with a control circuit, a motor, and the like.

The control circuit controls a drive system such as a motor. For example, the control circuit may supply power, a pulse, or the like to a drive system such as a motor, based on a signal from the control substrate 59.

The motor causes the first carriage 71 to move based on the power, the pulse, or the like from the control circuit. The motor establishes a connection to the first carriage 71 through a gear or a belt and causes the first carriage 71 to move.

The control substrate 59 controls the entire image reading apparatus 1. The control substrate 59 controls the original document supply unit 20, the light source 51, the CCD sensor substrate 58, the transportation mechanism 60, and the like. The control substrate 59 performs an operation of reading the original document P according to an operation by an operator. Furthermore, the control substrate 59 acquires the shading data for shading correction.

For example, the control substrate 59 may be configured with a processor or the like. A function that is to be implemented by the control substrate 59 is implemented by the processor executing a program that is stored in a memory. Furthermore, the control substrate 59 may be configured with an application specific integrated circuit (ASIC) or the like.

It is noted that the image reading apparatus 1 may employ a configuration according to need, other than a configuration that is illustrated in FIG. 1, and that the image reading apparatus 1 may exclude a specific configuration.

Next, an operational example of the image reading apparatus 1 will be described.

At this point, the operational example of the image reading apparatus 1 will be described based on an operational example of the control substrate 59.

First, an operational example of specifying an area (a data acquisition area) where the control substrate 59 acquires the shading data will be described.

The control substrate 59 specifies the data acquisition area according to the operation by the operator or the like. For example, the control substrate 59 specifies or updates the data acquisition area at the time of shipping, at the time of replacement of the white reference plate 30, or the like.

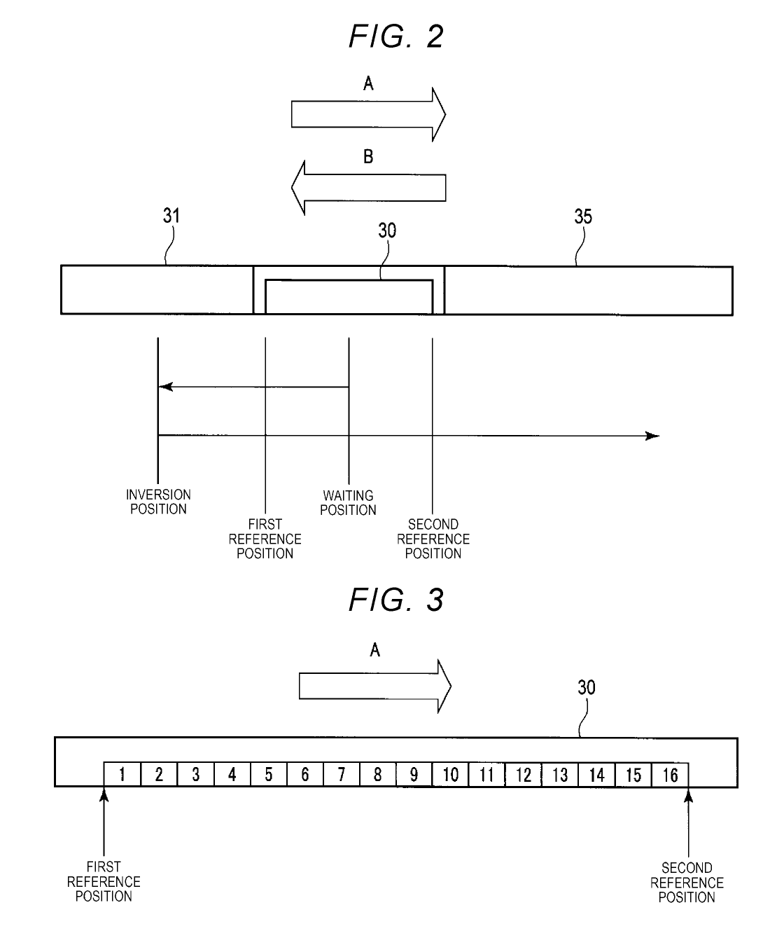

FIG. 2 illustrates a path along which the control substrate 59 causes the first carriage 71 to move. In an example that is illustrated in FIG. 2, in an initial state, the first carriage 71 is assumed to be in a “waiting position” that is present under the white reference plate 30.

First, the control substrate 59 causes the first carriage 71 to move in the B direction using the transportation mechanism 60. The control substrate 59 causes the first carriage 71 to move up to an “inversion position” that is present under the DF reading glass pane 31.

When the first carriage 71 is caused to move up to the “inversion position, the control substrate 59 causes the first carriage 71 to move in the A direction at a prescribed speed. The control substrate 59 causes the first carriage 71 to pass under the white reference plate 30.

The control substrate 59 detects an unwanted material (foreign matter) that is present on the white reference plate 30, using the first carriage 71. That is, the control substrate 59 acquires an image in the main scanning direction and detects the unwanted material. At this point, the control substrate 59 may cause the light source 51 to emit light. Furthermore, the control substrate 59 may cause the light source 51 to emit light in advance.

The control substrate 59 sets a plurality of blocks to be on the white reference plate 30 in the sub-scanning direction. The control substrate 59 detects whether or not an unwanted material is present on every block.

FIG. 3 illustrates an example of a block that is set by the control substrate 59. As illustrated in FIG. 3, the control substrate 59 sets a block to be within a range from a prescribed position (a first reference position) to a prescribed position (a second reference position) on the white reference plate 30. At this point, the control substrate 59 sets 16 blocks.

The control substrate 59 numbers the blocks 1 to 16, for example, in the A direction, as block numbers that indicate blocks.

When the first carriage 71 is caused to move up to the “first reference position,” the control substrate 59 acquires an image using the first carriage 71. For example, the control substrate 59 acquires one image (a line image) from the first carriage 71 at a fixed interval. Furthermore, the control substrate 59 causes the first carriage 71 to move at a prescribed speed. The control substrate 59 adjusts the speed or the like, and thus acquires one image (line image) on each block.

The control substrate 59 acquires a line image on each block using the first carriage 71 while causing the first carriage 71 to move up to the second reference position.”

The control substrate 59 determines whether or not a wanted material is present on each block, based on the line image. For example, when luminance of the line image is at or below a prescribed threshold (an unwanted-material determination threshold), the control substrate 59 determines that the unwanted material is present on a block which corresponds to the line image.

The control substrate 59 selects a block (a reading block) for acquiring the shading data from among blocks (valid blocks) that are determined as ones on which the unwanted material is not present. At this point, the control substrate 59 is assumed to need 32 line images, for example, as the shading data. Furthermore, if the shading data is acquired, the control substrate 59 is assumed to acquire four line images, for example, from one block. Therefore, the control substrate 59 selects eight reading blocks from among valid blocks.

For example, the control substrate 59 selects the reading block, in a left-justified manner, from among the valid blocks. That is, the control substrate 59 may select the reading block from among the valid blocks, starting from the valid block that is closest to the DF reading glass pane 31.

Furthermore, the control substrate 59 may select the reading block, in a right-justified, among from the valid blocks. That is, the control substrate 59 may select the reading block from among the valid blocks, starting from the valid block that is closest to the original document stand glass pane 35.”

The control substrate 59 specifies the selected reading block as the data acquisition area.

It is noted that for acquiring the unwanted-material determination value, the control substrate 59 may acquire the line image from the white reference plate 30 using the first carriage 71. For example, the control substrate 59 causes the first carriage 71 to move from the “first reference position” up to the “second reference position” and acquires the line image between the two positions.

Next, an operational example in which the control substrate 59 performs reading (manual reading) of the original document P on the original document stand glass pane 35 will be described. The operator is assumed to set the original document P to be on the original document stand glass pane 35.

The control substrate 59 starts to read the original document P on the original document stand glass pane 35 according to the operation by the operator or the like.

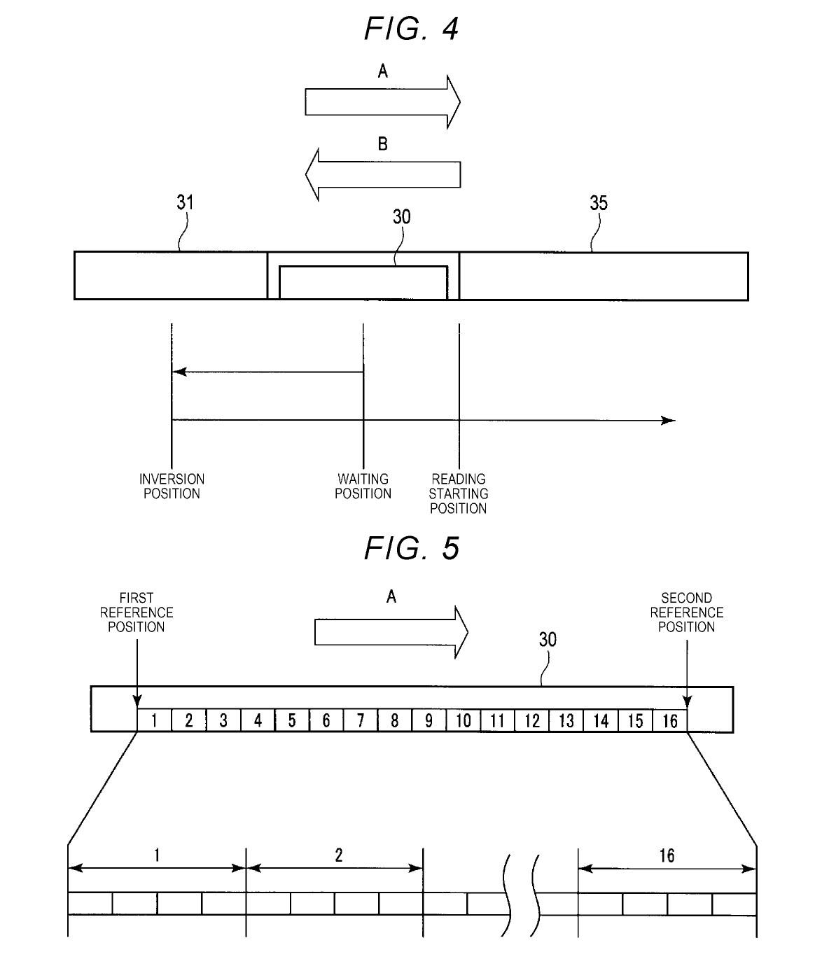

FIG. 4 illustrates a path along which the control substrate 59 causes the first carriage 71 to move. In an example that is illustrated in FIG. 4, in an initial state, the first carriage 71 is assumed to be in the “waiting position” that is present under the white reference plate 30.

First, the control substrate 59 causes the first carriage 71 to move in the B direction using the transportation mechanism 60. The control substrate 59 causes the first carriage 71 to move up to an “inversion position” that is present under the DF reading glass pane 31.

When the first carriage 71 is caused to move up to the “inversion position, the control substrate 59 causes the first carriage 71 to move in the A direction at a prescribed speed. The control substrate 59 causes the first carriage 71 to pass under the white reference plate 30. At this point, the control substrate 59 may cause the light source 51 to emit light. Furthermore, the control substrate 59 may cause the light source 51 to emit light in advance.

Furthermore, the control substrate 59 causes the first carriage 71, as is, to move in the A direction. The control substrate 59 causes the first carriage 71 to move up to an end edge of the original document P or an end edge of the original document stand glass pane 35.

The control substrate 59 acquires the shading data from the white reference plate 30 while the first carriage 71 is caused to move from the “first reference position” to the second reference position.”

FIG. 5 is a descriptive diagram for describing an operational example in which the control substrate 59 reads the shading data.

As described above, the control substrate 59 causes the first carriage 71 to move in the A direction. For example, the control substrate 59 causes the first carriage 71 to move at a speed lower than a speed that is the case when the unwanted material is detected. The control substrate 59 acquires the line image in the data reading position on the white reference plate 30, as the shading data.

That is, the control substrate 59 reads the line image from the reading block. As described above, the control substrate 59 reads four line images from one reading block.

As described above, the control substrate 59 selects eight reading blocks. Therefore, the control substrate 59 acquires 32 line images as the shading data.

When acquiring the shading data, the control substrate 59 acquires an image of the original document P. That is, the control substrate 59 acquires the line image of the original document P while causing the first carriage 71 to move in the A direction.

When acquiring the line image of the original document P, the control substrate 59 performs the shading correction based on the shading data. The shading correction is to correct luminance irregularity that occurs due to characteristic of an optical system or the like in order to acquire image data with uniform brightness. For example, the control substrate 59 adjusts luminance of an image in each position in the main scanning direction based on the shading data.

It is noted that the control substrate 59 may perform the shading correction further based on shading data in compliance with a black reference. For example, the control substrate 59 acquires the line image in a state where the light source 51 is switched off, and acquires the shading data in compliance with the black reference. Furthermore, the control substrate 59 may read a black reference plate and may acquire the shading data in compliance with the black reference.

Next, an operational example in which the control substrate 59 performs reading (DF reading) of the original document P from the original document supply unit 20 will be described. At this point, the operator is assumed to set the original document P to be on the original document supply unit 20.

The control substrate 59 starts to read the original document P on the original document supply unit 20 according to the operation by the operator or the like.

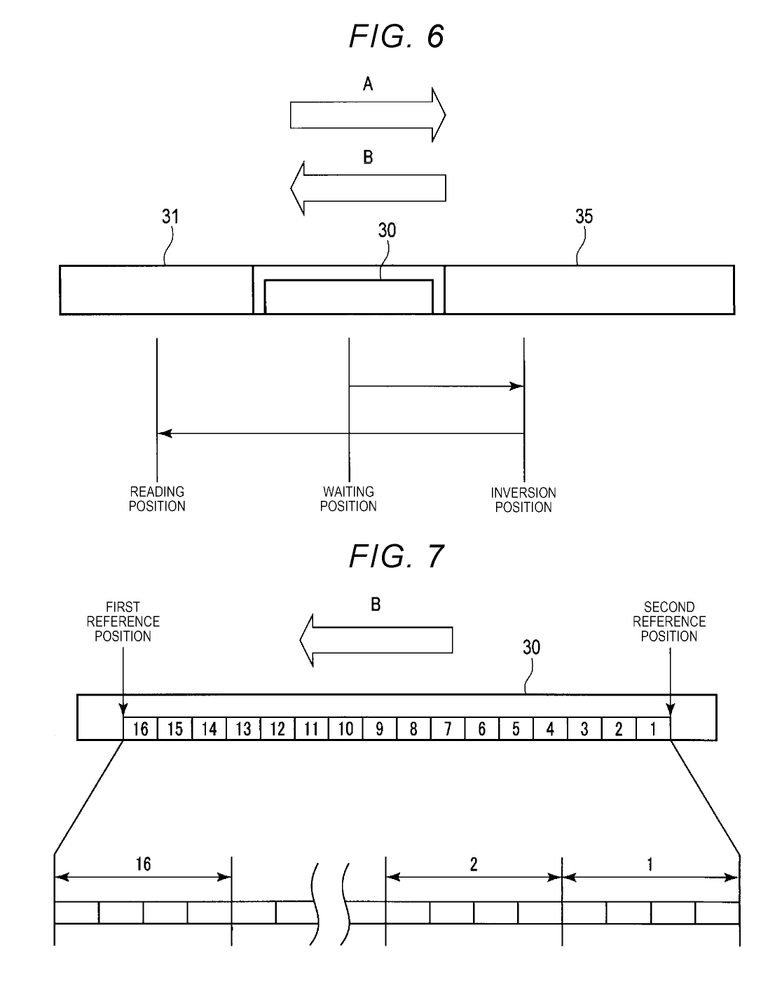

FIG. 6 illustrates a path along which the control substrate 59 causes the first carriage 71 to move. In an example that is illustrated in FIG. 6, in an initial state, the first carriage 71 is assumed to be in the “waiting position” that is present under the white reference plate 30.

First, the control substrate 59 causes the first carriage 71 to move in the A direction using the transportation mechanism 60. The control substrate 59 causes the first carriage 71 to move up to the “inversion position” that is present in a prescribed position which is present under the original document stand glass pane 35.

When the first carriage 71 is caused to move up to the “inversion position, the control substrate 59 causes the first carriage 71 to move in the B direction at a prescribed speed. The control substrate 59 causes the first carriage 71 to pass under the white reference plate 30. At this point, the control substrate 59 may cause the light source 51 to emit light. Furthermore, the control substrate 59 may cause the light source 51 to emit light in advance.

Furthermore, the control substrate 59 causes the first carriage 71, as is, to move in the B direction. The control substrate 59 causes the first carriage 71 to move up to a “reading position” that is present under the DF reading glass pane 31.

The control substrate 59 acquires the shading data from the white reference plate 30 while the first carriage 71 is caused to move from the “first reference position” to the second reference position.”

FIG. 7 is a descriptive diagram for describing an operational example in which the control substrate 59 reads the shading data.

The control substrate 59 sets a block to be within a range from the “second reference position” to the “first reference position.” As is the case when the data acquisition area is specified, the control substrate 59 sets 16 blocks.

The control substrate 59 numbers the blocks 1 to 16 in the B direction, as block numbers that indicate blocks.

The control substrate 59 acquires the line image in the data reading position on the white reference plate 30, as the shading data.

The control substrate 59 reads a line image from a block that corresponds to the selected reading block. That is, the control substrate 59 reads a line image from a block that is present in the same position as the reading block.

For example, in FIG. 5, if reading blocks are blocks numbered “1,” “2,” “4,” and “5,” the control substrate 59 reads line images from blocks numbered from “12,” “13,” “15,” and “16” in FIG. 7.

The control substrate 59 reads four line images from one block. As described above, the control substrate 59 selects reading blocks. Therefore, the control substrate 59 acquires 32 line images as the shading data.

When acquires the shading data, the control substrate 59 acquires a line image of the original document P.

That is, the control substrate 59 fixes the first carriage 71 to the “reading position.” When the first carriage 71 is fixed to the “reading position,” the control substrate 59 sends the original document to the DF reading glass pane 31 using the original document supply unit 20. The control substrate 59 acquires a line image and thus acquires a line image of the original document P, while the original document P passes the DF reading glass pane 31.

When acquiring the line image of the original document P, the control substrate 59 performs the shading correction based on the shading data. The shading correction is as described above, and therefore a description thereof is omitted.

The control substrate 59 generates an image of the original document from a line image that is read by the manual reading or the DF reading. The control substrate 59 stores the generated image in a prescribed memory or transmits the generated image to an external apparatus.

It is noted that, if an unwanted material on the white reference plate 30 is detected, the control substrate 59 may cause the first carriage 71 to move in the B direction. That is, the control substrate 59 causes the first carriage 71 to move up to a prescribed position on the original document stand glass pane 35, and causes the first carriage 71 to move in the B direction.

In this case, the control substrate 59 numbers blocks starting from a block that is closest to the original document stand glass pane 35. The control substrate 59 selects a reading block from among valid blocks. If the DF reading is performed, the control substrate 59 reads the shading data from the reading block. If the manual reading is performed, the control substrate 59 reads the shading data from a block that corresponds to the reading block.

Furthermore, the control substrate 59 may set a reading block that is on the black reference plate. The control substrate 59 may read the shading data from the reading block.

Furthermore, the image reading apparatus 1 may include a printer that prints the acquired image.

The image reading apparatus that is configured as described above causes the first carriage to move in the A direction and detects an unwanted material on the white reference plate. The image reading apparatus selects the data acquisition area for acquiring the shading data from an area other than an area where an unwanted material is present. If the first carriage is caused to move in the A direction and the shading data is acquired, the image reading apparatus acquires the shading data in the data acquisition area.

Furthermore, even if the first carriage is caused to move in the B direction and the shading data is acquired, the image reading apparatus acquires the shading data in the data acquisition area.

As a result, even if the first carriage is caused to move in the B direction, but an unwanted material is not detected, the image reading apparatus can set the data acquisition area when the first carriage is caused to move in the B direction. Therefore, the image reading apparatus can quickly set the data acquisition area relating to the A direction and the B direction.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image reading apparatus comprising:
a carriage configured to acquire an image in a main scanning direction;
a reference plate;
a transportation mechanism configured to transport the carriage in a sub-scanning direction; and
a processor configured to cause the carriage to move in a first direction via the transportation mechanism and thereby detect foreign matter present on the reference plate, using the carriage,
wherein when the carriage is caused to move in the first direction and shading data is acquired from the reference plate, the processor is configured to read the shading data from a data acquisition area other than an area where the foreign matter is present, and
wherein, when the carriage is caused to move in a second direction opposite to the first direction and the shading data is acquired from the reference plate, the processor is configured to read the shading data from the data acquisition area.

2. The apparatus according to claim 1,
wherein, the processor is configured to set a plurality of blocks on the reference plate,
detect whether the foreign matter exists on each block, and,
when the carriage is caused to move in the first direction and the shading data is acquired from the reference plate, read a reading block that is selected from among valid blocks on which the foreign matter is not detected.

3. The apparatus according to claim 2, wherein the processor is configured to acquire a line image for each block, and to determine whether foreign matter exists on each block based on the line image acquired for the block.

4. The apparatus according to claim 2,
wherein, when the carriage is caused to move in the second direction and the shading data is acquired from the reference plate, the processor is configured to read a block that corresponds to the reading block.

5. The apparatus according to claim 1,
wherein the processor is configured to cause the carriage to move in the first direction and to thereby read an original document on an original document stand.

6. The apparatus according to claim 1, further comprising:
an original document supply unit configured to send an original document,
wherein the processor is configured to cause the carriage to move in the second direction, stop the carriage in a prescribed position, and read the original document that is sent by the original document supply unit using the carriage.

7. The apparatus according to claim 1,
wherein the reference plate is white.

8. The apparatus according to claim 1,
wherein the reference plate is black.

9. The apparatus according to claim 1,
wherein the carriage includes an optical sensor that is configured with a mirror and is configured to convert light which is reflected from the mirror, into a signal, and
wherein the processor is configured to acquire the shading data using the optical sensor.

10. The apparatus according to claim 1, wherein the processor is configured to perform shading correction based on the shading data acquired from the reference plate.

11. The apparatus according to claim 10, wherein the shading correction includes adjusting luminance of the image.

12. A method of operating an image reading apparatus including a carriage configured to acquire an image in a main scanning direction and a reference plate, the method comprising:
moving the carriage in a first direction and thereby detecting foreign matter present on the reference plate, using the carriage,
wherein when the carriage is moved in the first direction and shading data is acquired from the reference plate, reading the shading data from a data acquisition area other than an area where the foreign matter is present, and
wherein when the carriage is moved in a second direction opposite to the first direction and the shading data is acquired from the reference plate, reading the shading data from the data acquisition area.

13. The method according to claim 12, further comprising:
setting a plurality of blocks on the reference plate,
detecting whether the foreign matter exists on each block, and,
when the carriage is moved in the first direction and the shading data is acquired from the reference plate, reading a reading block that is selected from among valid blocks on which the foreign matter is not detected.

14. The method according to claim 13, further comprising acquiring a line image for each block, and determining whether foreign matter exists on each block based on the line image acquired for the block.

15. The method according to claim 13,
wherein, when the carriage is moved in the second direction and the shading data is acquired from the reference plate, reading a block that corresponds to the reading block.

16. The method according to claim 12, further comprising
causing the carriage to move in the first direction and to thereby read an original document on an original document stand.

17. The method according to claim 12, further comprising:
sending an original document;
moving the carriage in the second direction;
stopping the carriage in a prescribed position; and
reading the sent original document using the carriage.

18. The method according to claim 12,
wherein the shading data is acquired using an optical sensor.

19. The method according to claim 12, further comprising performing shading correction based on the shading data acquired from the reference plate.

20. The method according to claim 19, wherein the performing shading correction includes adjusting luminance of the image.
